(19) United States
(12) Patent Application Publication
(10) Pub. No.: US 2016/0109995 A1
(43) Pub. Date: Apr. 21, 2016

(54) GAMING MACHINE

(71) Applicants: Gary Katzman, Orchards (ZA); Alan Simon Levy, Fairmount (ZA)

(72) Inventors: Gary Katzman, Orchards (ZA); Alan Simon Levy, Fairmount (ZA)

(21) Appl. No.: 14/721,983

(22) Filed: May 26, 2015

(30) Foreign Application Priority Data
Apr. 14, 2014 (ZA) 2014/02708
Oct. 21, 2014 (ZA) 2014/07648

(51) Int. Cl. G06F 3/048; G07F 17/34; G07F 17/32

(52) U.S. Cl. CPC G06F 3/048; G07F 17/3276; G07F 17/34; G07F 17/3204; G07F 17/3213; G07F 17/3244

(57) ABSTRACT

The application describes a gaming system including a gaming machine comprising a player registration module for receiving a registration request from a plurality of players, a wagering module to receive a wager from each of the plurality of players, a gaming module to randomly or pseudo randomly to select at least one of the players as a winner, and a display generating module for generating a display to be displayed to each of the players, the display including a spinning wheel with a number of slots, and a memory for storing player identifications, wagered amounts and selected winning player(s). In some examples, each slot on the spinning wheel includes a player identification, and the display generating module generates a display in which the spinning wheel spins and a first selection token moves into a slot displaying the player identification of the selected winning player(s).

### BACKGROUND OF THE INVENTION

This patent application relates to a gaming machine to enable a plurality of users to play a game, particularly in an on-line environment.

### SUMMARY OF THE INVENTION

According to a first aspect of the invention there is provided a gaming machine comprising:
a player registration module for receiving a registration request from each of a plurality of players, each registration request including a player selected identification comprising one or more of an alphanumeric text identifying the player and a graphic element identifying the player;
a wagering module to receive a wager from each of a plurality of players to enter a game and upon receipt of a wager from a player to enter the player into a game;
a gaming module to randomly or pseudo randomly select at least one of the players entered into the game as a winner; and
a display generating module for generating a display to be displayed to each of the plurality of players, the display including a spinning wheel with a number of slots, wherein each slot on the spinning wheel has a player identification displayed therein of a player that has entered the game, and wherein the display generating module degenerates a display in which the spinning wheel spins and a first selection token moves into a slot displaying the player identification of the selected winning player; and
a memory for storing player identifications, wagered amounts and selected winning players.

The system may further include a communications module via which communications with the plurality of players occurs and for transmitting the generated display to the plurality of players.

The displayed selection token may be in the form of a ball.

The number of slots in the displayed spinning wheel will be equal to the number of wagers received so that every slot will have a player identification displayed therein.

The wagering module may allow a player to enter more than one wager for a game in which case the player will be entered into the game a plurality of times, one for each wager received.

It will be appreciated that in this case some of the slots will have different player identifications displayed therein and some of the slots will have the same player identification displayed therein.

The communications module may be adapted to communicate over the Internet.

The gaming module may also randomly or pseudo randomly select at least one of the players entered into the game as a second winner in which case the display generating module will generate a second selection token moving into a slot displaying the player identification of the selected second winning player.

The first winning player and the second winning player may be the same player.

The machine preferably comprises an awards module for determining an award amount for the winning player or players.

The award amount may be the total amount wagered by the plurality of players for the game less an amount for the gaming machine administrators.

### BRIEF DESCRIPTION OF THE DRAWINGS

FIG. 1 shows a schematic drawing of a system in accordance with an example embodiment; and

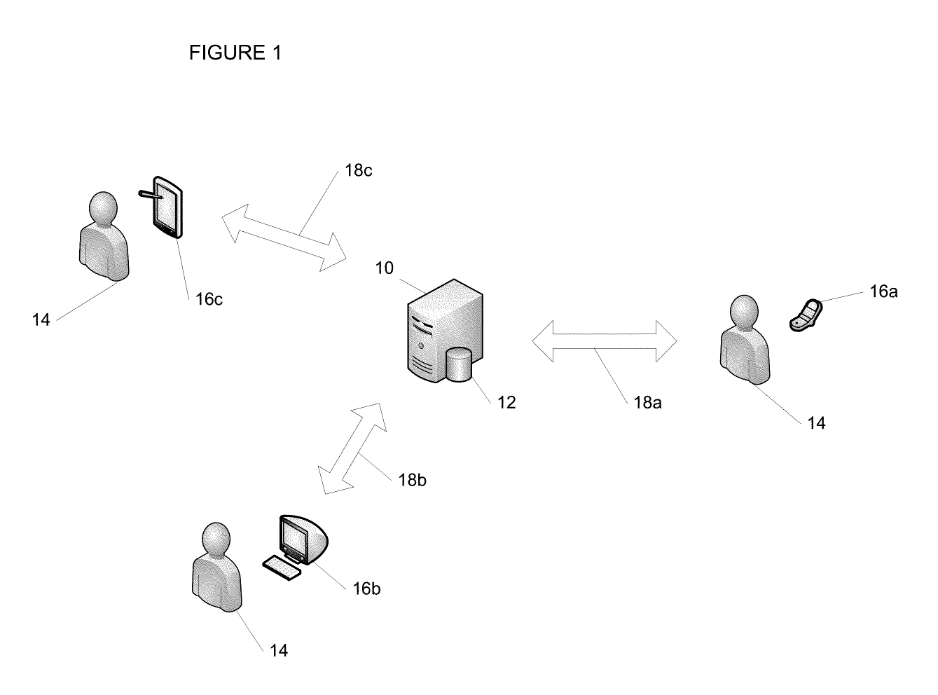

FIG. 2 shows a schematic drawing of the server of FIG. 1 in greater detail.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

Referring to the accompanying Figures, an example gaming machine is implemented by a server 10 with an associated memory 12.

The server 10 is accessed by a number of players 14 illustrated in the drawing.

In the illustrated example embodiment, the gaming machine 10 is accessed by players 14 who are remote from the gaming machine 10 and access the gaming machine using computing devices 16a-16c over communications networks 18a-18c.

It will be appreciated that the computing device 16 could be any suitable device and examples illustrated in the figure are a mobile telephone 16a, a desktop computer 16b and a tablet 16c.

The communications network 18 in the example embodiment is the Internet. However, it will be appreciated that the communications network 18 could be any other suitable communications network such as a local area network or a private network.

In one example embodiment, the gaming machine 10 could be located in a casino with a plurality of players 14 accessing the gaming machine 10 via a private network owned by the casino, using gaming terminals to wager and participate in a game as will be described in more detail below.

It will also be appreciated that the illustrated networks 18a-18c could be different networks so that the players 14 are accessing the gaming machine 10 using different devices over different networks.

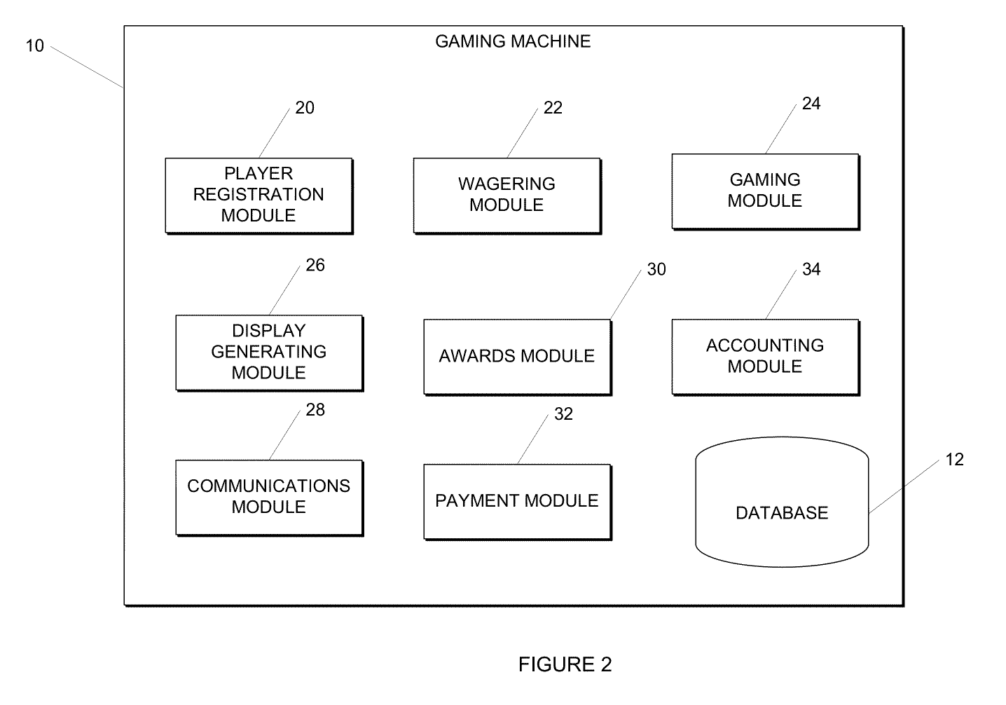

In any event, the server 10 includes a number of modules shown in FIG. 2.

In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices.

A player registration module 20 receives a registration request from each of a plurality of players, each registration request including a player selected identification comprising one or more of an alphanumeric text identifying the player and a graphic element identifying the player.

For example, a player may enter a name they would like to be used in the game described below such as “Gambling King” or could send through a graphic element such as a picture of themselves or something else to be used in the game.

The player may send through both a name and a graphic element to be used together.

The player's selected identification received is stored in memory 12.

A wagering module 22 receives a wager from each of a plurality of players to enter a game and upon receipt of a wager from a player enters the player into a game.

There are a number of methods of implementing the receipt of the wager including but not limited to providing the remote player, via the communications network, with an ability to enter their credit card details in which case the wager will be charged to their credit card.

The player could be charged, for example, for a single wager or could purchase a number of wagers which are credited towards the player and stored in the memory 12 in which case the player could select to use one or more of their credits to play a game.

In this type of scenario the player would need to be provided with a security mechanism such as a password that they would need to submit to allow them to use their credits.

In a casino environment, the player will typically insert tokens into a gaming terminal.

It will be appreciated that the above are some examples only of how the player could purchase one or more wagers.

In any event, once wagers are received from a plurality of players, each of the players are entered into the game.

A gaming module 24 randomly or pseudo randomly selects at least one of the players entered into the game as a winner.

A display generating module 26 generates a display to be displayed to each of the plurality of players via the network 18 and the relevant computer device 16.

The display will include a spinning wheel having a number of slots, wherein each slot on the spinning wheel has a player identification displayed therein of a player that has entered the game.

In this case the number of slots in the displayed spinning wheel will be equal to the number of wagers received so that every slot will have a player identification displayed therein.

The display generating module 26 will degenerate a display in which the spinning wheel spins and a first selection token typically in the form of a type ball moves into a slot displaying the player identification of the selected winning player.

It will be appreciated that in this way all the players who are participating in the game will immediately know if they are the winner or not.

A communications module 28 communicates with the plurality of players to transmit the generated display to the plurality of players.

In one example embodiment, the wagering module 22 allows a player to enter more than one wager for a game in which case the player will be entered into the game a plurality of times, one for each wager received and more than one slot on the wheel will then have the player's identification displayed therein.

In this scenario, it will be appreciated that some of the slots will have different player identifications displayed therein and some of the slots will have the same player identification displayed therein.

Alternatively or in addition, each player will occupy a percentage of the wheel based on their wager proportion of the total wagers placed.

In other words, instead of the wheel being divided into slots, in this example, each player will get a proportion of the wheel

In another example, the gaming module 24 randomly or pseudo randomly selects at least one of the players entered into the game as a second winner in which case the display generating module 26 will generate a second selection token moving into a slot displaying the player identification of the selected second winning player.

In this example, the gaming machine could also display multiple balls of different sizes and/or colours which denote different payouts.

The machine may be programmed to allow the first winning player and the second winning player to be the same player or not.

The machine also comprises an awards module 30 for determining an award amount for the winning player.

The award amount may be the total amount wagered by the plurality of players for the game less an amount for the gaming machine administrators.

This is paid out to the player via a payment module 32 which in one example embodiment transmits the required information to a third party financial institution to effect a payment to a banking account of the player.

Alternatively or in addition, a wager credit balance allocated to the player may be implemented by the winning amount. To this end, an accounting module 34 keeps track of wagers paid by the player and winnings are received by the player.

Player identifications, wagered amounts and selected winning players are all stored in memory 12.

1. A gaming machine comprising:
a player registration module for receiving a registration request from each of a plurality of players, each registration request including a player selected identification comprising one or more of an alphanumeric text identifying the player and a graphic element identifying the player;
a wagering module to receive a wager from each of a plurality of players to enter a game and upon receipt of a wager from a player to enter the player into a game;
a gaming module to randomly or pseudo randomly select at least one of the players entered into the game as a winner;
a display generating module for generating a display to be displayed to each of the plurality of players, the display including a spinning wheel with a number of slots, wherein each slot on the spinning wheel has a player identification displayed therein of a player that has entered the game, and wherein the display generating module degenerates a display in which the spinning wheel spins and a first selection token moves into a slot displaying the player identification of the selected winning player; and
a memory for storing player identifications, wagered amounts and selected winning players.

2. A system according to claim 1 further including a communications module via which communications with the plurality of players occurs and for transmitting the generated display to the plurality of players.

3. A system according to claim 1 wherein the displayed selection token is in the form of a ball.

4. A system according to claim 1 wherein the number of slots in the displayed spinning wheel will be equal to the number of wagers received so that every slot will have a player identification displayed therein.

5. A system according to any of claim 1 wherein the number of slots in the displayed spinning wheel will be equal to the number of players where each player will occupy a percentage of the wheel based on their wager proportion of the total wagers placed.

6. A system according to claim 1 wherein the wagering module allows a player to enter more than one wager for a game in which case the player will be entered into the game a plurality of times, one for each wager received.

7. A system according to claim 6 wherein some of the slots will have different player identifications displayed therein and some of the slots will have the same player identification displayed therein.

8. A system according to claim 1 wherein the communications module is adapted to communicate over the Internet.

9. A system according to claim 1 wherein the gaming module randomly or pseudo randomly selects at least one of the players entered into the game as a second winner in which case the display generating module will generate a second selection token moving into a slot displaying the player identification of the selected second winning player.

10. A system according to claim 9 wherein the first winning player and the second winning player may be the same player.

11. A system according to claim 1 wherein the machine comprises an awards module for determining an award amount for the winning player or players.

12. A system according to claim 11 wherein the award amount may be the total amount wagered by the plurality of players for the game less an amount for the gaming machine administrators.

13. A system according to claim 2 wherein the displayed selection token is in the form of a ball.

14. A system according to claim 2 wherein the number of slots in the displayed spinning wheel will be equal to the number of wagers received so that every slot will have a player identification displayed therein.

15. A system according to claim 3 wherein the number of slots in the displayed spinning wheel will be equal to the number of wagers received so that every slot will have a player identification displayed therein.

16. A system according to claim 2 wherein the number of slots in the displayed spinning wheel will be equal to the number of players where each player will occupy a percentage of the wheel based on their wager proportion of the total wagers placed.

17. A system according to claim 3 wherein the number of slots in the displayed spinning wheel will be equal to the number of players where each player will occupy a percentage of the wheel based on their wager proportion of the total wagers placed.

18. A system according to claim 2 wherein the wagering module allows a player to enter more than one wager for a game in which case the player will be entered into the game a plurality of times, one for each wager received.

19. A system according to claim 4 wherein the wagering module allows a player to enter more than one wager for a game in which case the player will be entered into the game a plurality of times, one for each wager received.

20. A system according to claim 5 wherein the wagering module allows a player to enter more than one wager for a game in which case the player will be entered into the game a plurality of times, one for each wager received.
